(19) United States
(12) Patent Application Publication
(10) Pub. No.: US 2013/0136395 A1
(43) Pub. Date: May 30, 2013

(54) OPTICAL FIBER TRANSMITTING SYSTEM

(71) Applicant: KAI-WEN WU, Tu-Cheng (TW)

(72) Inventor: KAI-WEN WU, Tu-Cheng (TW)

(73) Assignee: HON HAI PRECISION INDUSTRY CO., LTD., Tu-Cheng (TW)

(21) Appl. No.: 13/314,192

(22) Filed: Dec. 8, 2011

(30) Foreign Application Priority Data
Nov. 28, 2011 (TW) 100143512

(51) Int. Cl. G02B 6/26

(52) U.S. Cl. 385/27

(57) ABSTRACT

An optical fiber transmitting system including a first Optical/Electrical (O/E) module, a first interface, a second interface, a fiber cable and a second Optical/Electrical (O/E) module is provided. The first O/E module includes a laser diode (LD) configured to emit laser optical signals. The fiber cable includes two pieces of optical fiber and a third piece of optical fiber for transmitting the laser optical signals to the second O/E module via the first interface and the second interface. The second O/E module includes a photo-detector (PD) configured to convert the laser optical signals into electronic signals to supply power energy to a peripheral device.

### BACKGROUND

1. Technical Field

The present disclosure relates to an optical fiber transmitting system and, particularly, to an optical fiber transmitting system applied for Thunderbolt™ technology thereof.

2. Description of Related Art

FIG. 1 is a block diagram of a traditional optical fiber transmitting system applied for the Thunderbolt™ technology. An optical fiber transmitting device 30 is connected with a computer 10 and a peripheral device 20. The optical fiber transmitting device 30 includes a first Optical/Electrical (O/E) module 300a, a first interface 302a, a fiber cable 304, a second interface 302b, and a second Optical/Electrical (O/E) module 300b. The first O/E module 300a is configured to convert electronic signals connected with the computer 10 into optical signals via the first interface 302a, the fiber cable 304 and the second interface 302b, and send to the second O/E module 300b. The optical fiber transmitting device 30 includes two pieces of optical fiber 3041 for transmitting the optical signals and two pieces of traditional electric wire 3042 for transmitting power energy. The second O/E module 300b is configured to convert the optical signals obtained by the second interface 302b into electronic signals, and send to the peripheral device 20.

However, as the traditional electrical wire usually uses copper to transmit power energy, the advantage of the optical fiber transmitting is decreased.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of a traditional optical fiber transmitting system applied for the Thunderbolt™ technology.

FIG. 2 is a block diagram of one embodiment of an optical fiber transmitting system applied for the Thunderbolt™ technology, in accordance with the present disclosure.

### DETAILED DESCRIPTION

Embodiments of the present disclosure will now be described in detail below, with reference to the accompanying drawings.

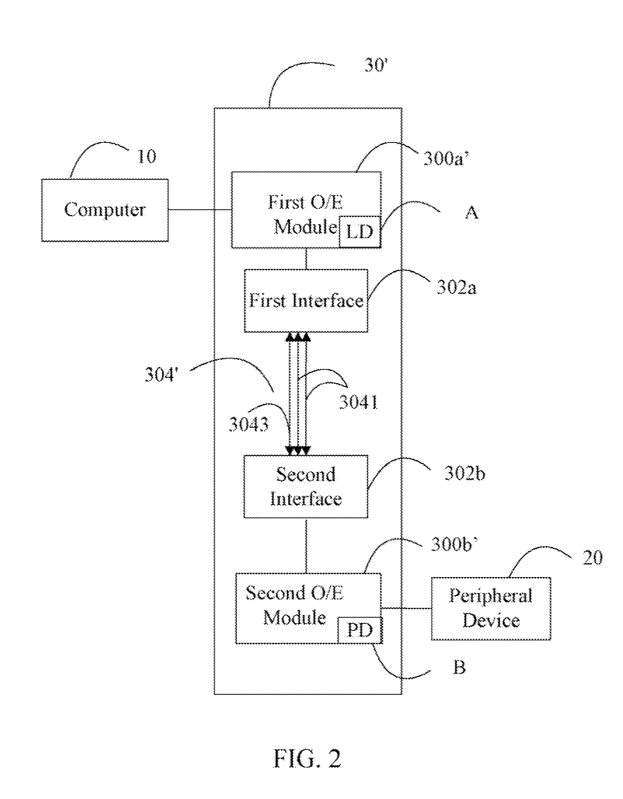

The present disclosure discloses transmitting power energy by the optical fiber instead of the copper wire. FIG. 2 is a block diagram of one embodiment of an optical fiber transmitting system applied for the Thunderbolt™ technology in accordance with the present disclosure.

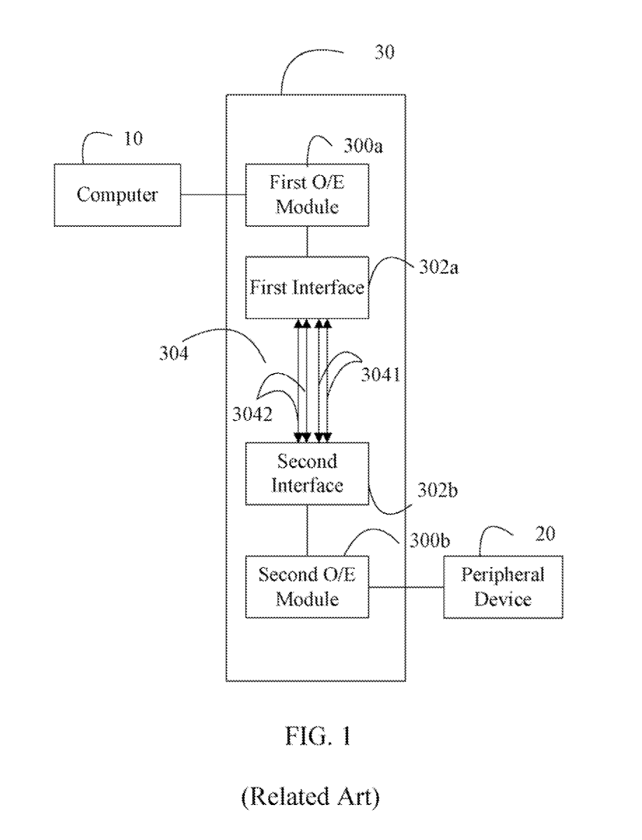

Compared with FIG. 1, an optical fiber transmitting system 30′ of the present disclosure adds a laser diode (LD) A into the first O/E module 300a′ and a photo-detector (PD) B into the second O/E module 300b′. The fiber cable 304′ includes a third piece of optical fiber 3043 instead of the two pieces of copper wire 3042.

The laser diode (LD) A is configured to emit laser optical signals, and transmit the laser optical signals to the second O/E module 300b′ via the first interface 302a, the third piece of the fiber cable 3043, and the second interface 302b. The photo-detector (PD) B is configured to convert the laser optical signals obtained by the second interface 302b into electronic signals to supply power energy to the peripheral device 20. The photo-detector (PD) B does not need bias voltage. Through the laser diode (LD) A, the third piece of the fiber cable 3043, and the photo-detector (PD) B, the optical fiber transmitting system 30′ transmits optical signals and converts the laser optical signals into electronic signals to supply power energy to the peripheral device 20 instead of the copper wire, thereby keeping the advantage of the optical fiber transmitting.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An optical fiber transmitting system comprising:
a first Optical/Electrical (O/E) module, configured to convert electronic signals connected with a computer into optical signals and comprising a laser diode (LD) configured to emit laser optical signals;
a first interface and a second interface;
a second Optical/Electrical (O/E) module; and
a fiber cable, comprising two pieces of optical fiber for transmitting the optical signals and a third piece of optical fiber for transmitting the laser optical signals to the second O/E module via the first interface and the second interface;
wherein the second O/E module comprises a photo-detector (PD) configured to convert the laser optical signals into electronic signals to supply power energy to a peripheral device.

2. The optical fiber transmitting system of claim 1, wherein the photo-detector (PD) is a PD which does not need to be supplied with bias voltage.
